(19) United States
(12) Patent Application Publication
(10) Pub. No.: US 2013/0247772 A1
(43) Pub. Date: Sep. 26, 2013

(54) BEVERAGE MACHINE WITH RELIABLE USER-INDICATOR

(71) Applicants: Fabien Ludovic Agon, Le Bouveret (CH); Gilles Gavillet, Ursy (CH); Peter Mori, Walperswil (CH)

(72) Inventors: Fabien Ludovic Agon, Le Bouveret (CH); Gilles Gavillet, Ursy (CH); Peter Mori, Walperswil (CH)

(73) Assignee: NESTEC S.A., Vevey (CH)

(21) Appl. No.: 13/991,339

(22) PCT Filed: Dec. 1, 2011
(86) PCT No.: PCT/EP11/71551

§ 371 Date: Jun. 3, 2013

(30) Foreign Application Priority Data
Dec. 1, 2010 (EP) 10193230.9

(51) Int. Cl. A47J 31/44

(52) U.S. Cl. CPC A47J 31/4403
USPC 99/285

(57) ABSTRACT

A beverage machine comprises: a processing unit (60) that has a flavouring module (10) for mixing liquid with a flavouring ingredient to form a flavoured beverage, and that has a liquid drive arrangement (65) for in-taking liquid from a source (200) of liquid and driving said liquid to the flavouring module, and that has an outlet (12) for guiding a flavoured beverage from the flavouring module to a beverage dispensing area (12′); and a user-interface that is connected to the processing unit and that has an indicator for indicating a status of the processing unit. The indicator (1, 2, 3, 4, 5, 6, 7) is displaceable, in particular relatively to the processing unit, in a manner visible from outside such machine by a mechanical, magnetic and/or thermal actuation thereof by the processing unit changing status.

### FIELD OF THE INVENTION

The field of the invention pertains to beverage preparation machines, in particular using capsules of an ingredient of the beverage to be prepared, such as beverage preparation machines having a user-interface for communicating information to a user relative to the machine's status.

For the purpose of the present description, a “beverage” is meant to include any human-consumable liquid substance, such as tea, coffee, hot or cold chocolate, milk, soup, baby food, etc. . . . A “capsule” is meant to include any pre-portioned beverage ingredient, such as a flavouring ingredient, within an enclosing packaging of any material, in particular an airtight packaging, e.g. plastic, aluminium, recyclable and/or biodegradable packagings, and of any shape and structure, including soft pods or rigid cartridges containing the ingredient.

### BACKGROUND ART

Certain beverage preparation machines use capsules containing ingredients to be extracted or to be dissolved and/or ingredients that are stored and dosed automatically in the machine or else are added at the time of preparation of the drink.

Some beverage machines possess filling means that include a pump for liquid, usually water, which pumps the liquid from a source of water that is cold or indeed heated through heating means, such as a heating resistor, a thermoblock or the like.

For allowing the user to interact with such machines, for providing operation instructions to the machine or obtaining feed-back therefrom, various systems have been disclosed in the art, for instance as mentioned in the following references: AT 410 377, CH 682 798, DE 44 29 353, DE 10 2005 057 166, DE 20 2005 002 814, DE 20 2006 019 039, EP 1 448 084, EP 1 676 509, EP 1 707 088, EP 08 155 851.2, FR 2 624 844, FR 2 858 713, GB 2 240 206, GB 2 397 510, GB 2 240 206, U.S. Pat. No. 4,253,385, U.S. Pat. No. 4,377,049, U.S. Pat. No. 4,458,735, U.S. Pat. No. 4,554,419, U.S. Pat. No. 4,767,632, U.S. Pat. No. 4,954,697, U.S. Pat. No. 5,312,020, U.S. Pat. No. 5,335,705, U.S. Pat. No. 5,372,061, U.S. Pat. No. 5,375,508, U.S. Pat. No. 5,645,230, U.S. Pat. No. 5,731,981, U.S. Pat. No. 5,836,236, U.S. Pat. No. 5,927,553, U.S. Pat. No. 5,959,869, U.S. Pat. No. 6,182,555, U.S. Pat. No. 6,354,341, U.S. Pat. No. 6,759,072, U.S. Pat. No. 7,028,603, U.S. Pat. No. 7,270,050, U.S. Pat. No. 7,279,660, U.S. Pat. No. 7,350,455, US 2007/0157820, WO 97/25634, WO 99/50172, WO 03/037151, WO 03/039309, WO 2004/030435, WO 2004/030438, WO 2006/063645, WO 2006/082064, WO 2006/090183, WO 2007/003062, WO 2007/003990, WO 2008/104751, WO 2008/138710 and WO 2008/138820.

In particular, in AT 410 377 a touch screen is used in a beverage machine to provide a feed-back of values measured in the machine by using sensors, such as the temperature of a beverage or a supply pressure including the use of a red-green signal. EP 1 448 084 and WO 03/037151 disclose a beverage machine with a display that indicates in a corner the statement “Warming up. Please wait!” when in its start-up mode. Likewise, U.S. Pat. No. 4,767,632 discloses a beverage machine with a display adapted to display an error message, such as “COFFEE MILL DEFECTIVE”, “RESERVOIR EMPTY”, “WATER TANK EMPTY” or “PUMP DEFECTIVE”. U.S. Pat. No. 4,253,385 discloses a beverage machine having a lamp that is switched on while the machine's heater is being powered. GB 2 397 510 discloses a coffee machine with a series of indicator LEDs, one of which may be used to indicate a low water level in the machine's tank. A similar interface arrangement is disclosed in U.S. Pat. No. 5,836,236 and in WO 2008/104751. DE 202 00 419 discloses a beverage preparation machine that has a user-interface that is separable from the machine for remote operation.

There is still a need to provide beverage machines with an economic and reliable and ergonomic user-interface that provides proper information regarding the machine's status.

### SUMMARY OF THE INVENTION

The invention relates to a machine for preparing and dispensing a beverage. For instance, the machine is a coffee, tea, chocolate, cacao, milk or soup preparation machine. In particular, the machine is arranged for preparing within a beverage module a beverage by passing hot or cold water or another liquid through a capsule containing an ingredient, such as a flavouring ingredient, of the beverage to be prepared, such as ground coffee or tea or chocolate or cacao or milk powder.

The beverage machine comprises:
a processing unit that has a flavouring module for mixing liquid with a flavouring ingredient to form a flavoured beverage, and that has a liquid drive arrangement for in-taking liquid from a source of liquid and driving said liquid to the flavouring module, and that has an outlet for guiding a flavoured beverage from the flavouring module to a beverage dispensing area; and
a user-interface that is connected to the processing unit and that has an indicator for indicating a status of the processing unit.

Such beverage preparation typically includes the mixing of a plurality of beverage ingredients, e.g. water and milk powder, and/or the infusion of a beverage ingredient, such as an infusion of ground coffee or tea with water. For instance, a predetermined amount of beverage is formed and dispensed on user-request, which corresponds to a serving. The volume of such a serving may be in the range of 25 to 200 ml, e.g. the volume for filling a cup or mug, depending on the type of beverage. Formed and dispensed beverages may be selected from ristrettos, espressos, lungos, cappuccinos, café latte, americano coffees, teas, etc. . . . In particular, a coffee machine may be configured for dispensing espressos, e.g. an adjustable volume of 20 to 60 ml per serving, and a and/or for dispensing lungos, e.g. a volume in the range of 70 to 150 ml per serving.

In accordance with the invention, the indicator is displaceable, typically displaceable relatively to the processing unit, in a manner visible from outside such machine by a mechanical, magnetic and/or thermal actuation thereof by the processing unit changing status.

A user normally operating the machine, e.g. for preparing/dispensing a beverage and/or routine servicing the machine, will be able to monitor visually the displacement of the indicator. Typically, such user indicator serves no other purpose or has no other function than the indication of the status to a user. In particular, the indicator does not participate in the operation of the beverage machine beyond providing information to a user, i.e. the absence of the indicator does not deprive the beverage machine of any operative function such as beverage preparation function or servicing function.

Hence, instead of using state of the art user-interfaces, e.g. LED's, screens, touch screens, etc. . . . , that require sensors and an electric or electronic control logic, such as a processor, that are expensive and involve a significant risk of failure and/or malfunction over time, the user-interface of the invention includes a robust movable indicator that is not depending on any electronic control arrangement. Hence, information regarding the status of the processing unit during start-up, operation, shut down, idling, standby, etc. . . . can be communicated to a user in a simple and reliable manner using an inexpensive and robust interface arrangement. Moreover, such arrangement does not involve additional/dedicated powering like an electric interface and does not require the use of materials that are environmentally unfriendly as encountered in electronic devices.

In one embodiment, the status of the processing unit is arranged to change incrementally, the indicator being movable accordingly incrementally, in particular within a range of 2 to 5 increments such as two or three increments. Such status may relate to the state of operation of the processing unit, e.g. in the process of preparing or not preparing a beverage, in a configuration for loading/unloading an ingredient or in a loaded configuration, etc. . . .

In another embodiment, the status of the processing unit is arranged to change progressively, the indicator being movable accordingly, i.e. progressively. Such a status may relate to a the speed or pressure of liquid circulating in the processing unit or to the temperature of the a thermal conditioner such as a heater during start-up.

Typically, the beverage machine has an outermost housing, the indicator being arranged to extend through the outermost housing. The indicator may also be arranged to move within the housing underneath an opening of the housing to remain visible from outside the housing via the opening. In another configuration, the beverage machine has an outermost housing, the indicator being arranged to move behind a transparent part of the housing, e.g. to be visible by a user but protected from the environment outside the machine.

The indicator of the machine's interface may be translationally and/or pivotally movable between two predetermined end positions. The indicator can be movable in rotation generally infinitely (i.e. not confined inbetween two predetermined end positions), in particular to indicate a velocity, such as a velocity of the liquid circulated in the processing unit.

The processing unit may comprise a thermal conditioner for the in-taken liquid, the indicator being arranged for indicating a thermal status of the thermal conditioner. The thermal conditioner may be a cooler or a heater such as a boiler or an in-line heater, e.g. a thermoblock or an instant heater. For instance, the indicator comprises or is connected to a temperature-sensitive mechanical element, such as a thermal expansive element or a bimetallic element in particular a bimetallic strip, in thermal communication with the thermal conditioner.

The processing unit can comprises a part that is movable by a change of status and that is mechanically connected to the indicator so as to displace the indicator when the part is moved. Typically, this movable part of the processing unit forms a part of the flavouring module. The flavouring module may comprise a further part that cooperates with this movable part, the movable part being movable relative to the further part: away from the further part for introducing a flavouring ingredient, in particular contained within a capsule, into the flavouring module and/or for evacuating a used flavouring ingredient therefrom; and towards the further part for forming a mixing cavity that holds such flavouring ingredient and that guides a flow of liquid therethrough for flavouring such liquid and that is arranged to deliver such flavoured liquid to a beverage outlet.

The movable part of the flavouring module can be motorized. In this case, the user does not have to operate a handle for handling the ingredient, e.g. contained within a capsule, in the flavouring module, this being done automatically by a motor. In this case, the indicator may provide the feed-back to the user as to the status of the flavouring module, e.g. in a loading or unloading configuration or in a beverage preparation configuration, i.e. loaded with a flavouring ingredient. A suitable example of a motorization of a flavouring module is disclosed in EP 1 767 129.

Furthermore, the processing unit typically comprises a fluid conduit. The fluid conduit is arranged to intake liquid from the liquid source. Without being part thereof, the liquid source is in fluid communication with the processing unit for supplying the processing unit with liquid, as needed. Hence, the liquid source may be disconnectably connected or connectable to the processing unit, in particular to the fluid conduit thereof.

The status of such a fluid conduit may be indicated to a user via the indicator of the invention. For instance, the processing unit is associated with at least one of:
a body drivable by a change of pressure in the fluid conduit, such as a flexible portion of the fluid conduit, that forms said movable part;
a body drivable by a flow in the fluid conduit, such as a rotatable measuring body extending into the fluid conduit; and/or

a pump having a drive body, such as a reciprocating piston or a rotatable impeller, for driving through the pump this liquid, the pump, in particular the drive body, forming a mechanical and/or magnetic actuator of the indicator.

### BRIEF DESCRIPTION OF THE DRAWINGS

The invention will now be described with reference to the schematic drawings, wherein:

FIGS. 1 and 2 illustrate a brewing unit with a user-interface of a beverage preparation machine according to the invention;

FIGS. 3 to 5 illustrate a brewing unit with another user-interface of a beverage preparation machine according to the invention;

FIGS. 6 to 8b illustrate a brewing unit with yet another user-interface of a beverage preparation machine according to the invention; and

FIG. 9 illustrate a processing unit with a plurality of user-interfaces of a beverage preparation machine according to the invention.

### DETAILED DESCRIPTION

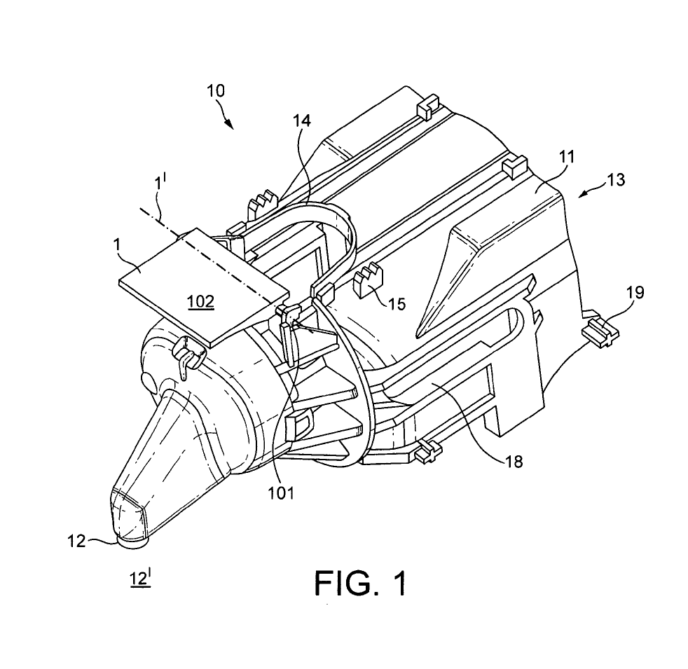

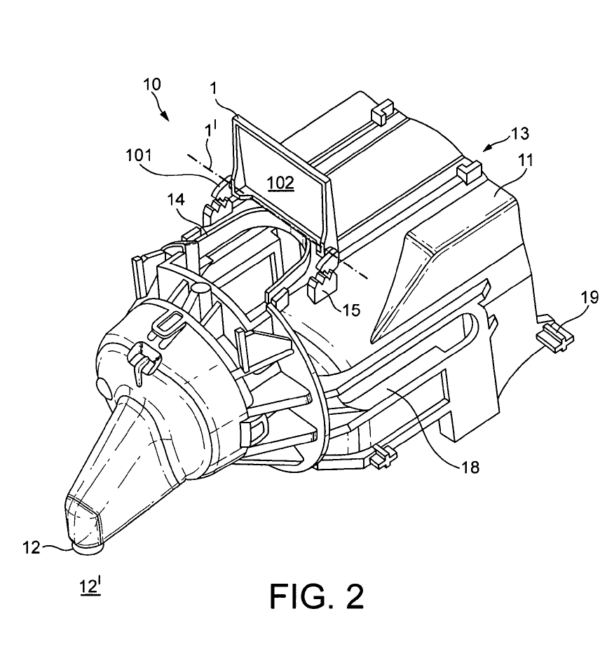

FIGS. 1 and 2 illustrate a first embodiment of a user-interface 1 for an embodiment of a beverage preparation machine in accordance with the invention.

User-interface 1 is associated with a flavouring module 10, e.g. a brewing unit, of a processing unit of the machine. For the purpose of illustrating this embodiment of the invention, only a movable front part 11 is shown together with interface 1. Movable front part 11 may cooperate with a rear part, as for instance following the principle disclosed in PCT/EP10/064,772. In particular, the brewing unit illustrated in this reference may be fully motorized, e.g. the handle (manual) actuation of the brewing unit may be replaced by a motorized actuation.

Flavouring module 10 of the processing unit is arranged for mixing liquid, such as an incoming flow of hot water, with a flavouring ingredient, e.g. coffee or tea, to form a flavoured beverage.

The flavouring ingredient may be supplied within a capsule into the brewing unit. The interaction between the brewing unit and the flavouring ingredient, when provided within a capsule, may be of the type disclosed in EP 1 859 714 or in EP 2 205 133.

Furthermore, the processing unit includes a liquid drive arrangement, such as a fluid conduit with a pump that is connectable to a source of liquid external to the processing unit, such as the tap or a water reservoir. The source of liquid may be part of the beverage machine, e.g. in the form of a liquid reservoir, or distinct therefrom. The pump (not shown) is configured for in-taking liquid from the liquid source into the processing unit and circulating the in-taken liquid through the processing unit via the flavouring module 10 to a beverage dispensing area 12′ via an outlet 12. Suitable examples of liquid reservoirs are for example disclosed in EP 10 151 317.

User-interface 1 is connected to flavouring module 10 of the processing unit (FIG. 2) and has an indicator 102 for indicating a status of the processing unit, namely of the flavouring module 10 in this embodiment of the invention.

In accordance with the invention, indicator 1 is displaceable relatively to the processing unit in a manner visible from outside the machine by a mechanical actuation of indicator 1 by the processing unit changing status.

The beverage machine has a housing (not shown) in which indicator 1 is pivotally mounted about an axis 1′ fixed in the housing.

Flavouring module 10 has a downstream part 11 bearing beverage outlet 12 that cooperates with an upstream part (not shown). Downstream part 11 is translationally movable relative to the upstream part towards and away thereof. The upstream part may be fixed in the housing or movable. In particular, downstream part 11 has an opening 13 that may slide over the upstream part. Lateral openings 18 are provided for guiding downstream part 18 in the machine's housing along the housing or along a stationary machine part in the housing, e.g. along the heater. Part 11 may include a connector 19 for driving downstream part 11 in the machine's housing to and away from the upstream part. For instance, downstream part 11 is driven automatically by an electric motor. Upstream and a downstream parts of this type are illustrated in greater details in the abovementioned references.

When closed capsules of flavouring ingredients are used, flavouring module 10 may include a capsule opener such as blades and/or a tearing tool, e.g. a plate with a tearing profile, for instance as known form Nespresso™ machines.

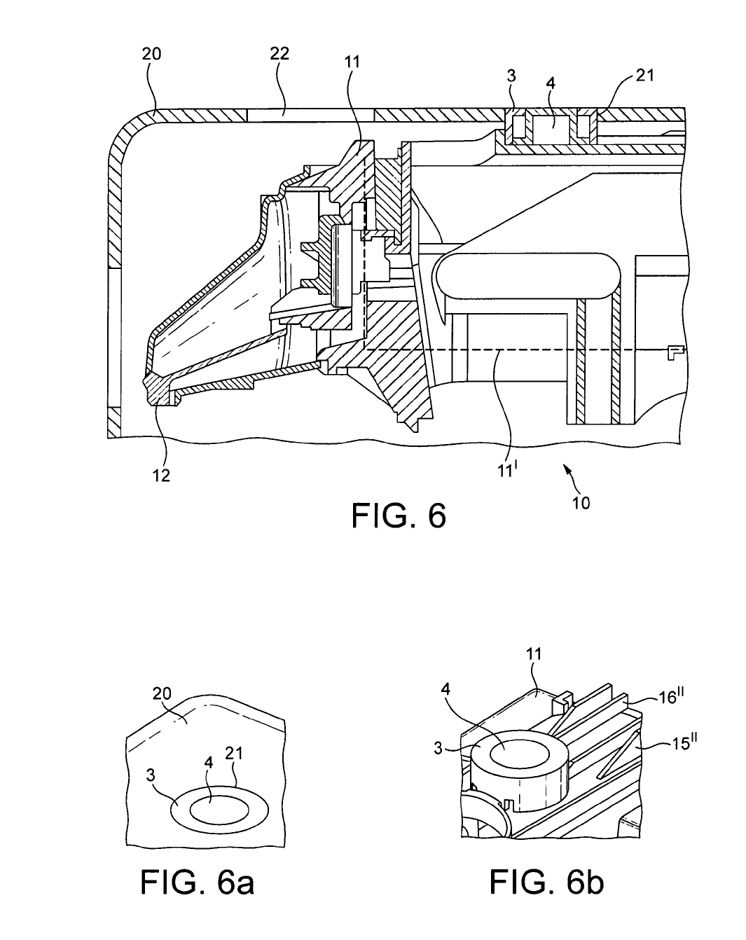

As for example illustrated in FIGS. 6 to 8, flavouring module 10 has a first part 11 that is movable between: the transfer position for introducing a beverage ingredient, e.g. a flavouring ingredient such as ground coffee or tea, into the flavouring chamber and/or for removing the ingredient therefrom; and the processing position for forming the beverage from the ingredient in module 10, in particular by circulating water therethrough.

Flavouring module 10 may include two relatively movable parts 11,11′ to form an ingredient chamber 11″ in the processing position, such as a brewing unit, of the beverage preparation module. These parts 11,11′ are relatively movable from: the transfer position for insertion of the flavouring ingredient into the chamber and/or evacuation of this ingredient therefrom; and a processing position for circulating the liquid through this ingredient in the chamber of flavouring module 10 to form the beverage. Relatively movable parts 11,11′ can be manually and/or automatically movable apart for opening flavouring module 10 into the transfer position and moved together for closing flavouring module 10 into the processing position. In the processing position, module 10 may tightly enclose the ingredient, typically a solid ingredient such as ground coffee, tea leaves or milk powder, to ensure proper guidance of the liquid through the ingredient.

For instance, an automatic actuator for moving movable part 11 of module 10 may be controlled to move part 11 from the processing position to the transfer position automatically at the end of a beverage formation.

The beverage machine typically includes one or more of the following components, as schematically illustrated in the Figs:
a) module 10, e.g. a brewing unit, delimiting in the processing position an inner flavouring chamber for receiving an ingredient of the beverage such as a flavouring ingredient, in particular a pre-portioned ingredient supplied within a capsule, and for guiding via an inlet an incoming flow of liquid for flavouring thereof, such as water, through this ingredient to beverage outlet 12;
b) an in-line heater 66, such as a thermoblock, for heating this flow of liquid to be supplied to the ingredient holder;
c) a pump 65 for pumping liquid through the in-line heater 66 module 10;
d) one or more fluid connecting members 61,62,63,64 for guiding liquid from a source of liquid, such as tank of liquid 200, to module 10;
e) an electric control unit (not shown), in particular comprising a printed circuit board (PCB), for receiving instructions from a user via an input user-interface (not shown) and for controlling in-line heater 66 and the pump 65; and/or
f) one or more sensors for sensing at least one characteristic selected from characteristics of module 10, the in-line heater 66, the pump 65, liquid tank 200, an ingredient receptacle, a flow of the liquid (e.g. by a flowmeter 7,7a), a pressure of the liquid and a temperature of the liquid, and for communicating such characteristic(s) to the control unit.

The heater may be a thermoblock or an on demand heater (ODH), for instance an ODH type disclosed in EP 1 253 844, EP 1 380 243 and EP 1 809 151. Examples of suitable brewing units and capsule management are for example disclosed in WO 2005/004683, WO2007/135136 and WO 2009/043630, which are hereby incorporated by way of reference. Suitable beverage preparation modules are for instance disclosed in WO 2009/074550 and WO 2009/130099, which are hereby incorporated by way of reference.

FIG. 1 illustrates downstream part 11 when urged against the upstream part (not shown). FIG. 2 shows downstream part 11 when spaced away from the upstream part.

Downstream part 11 includes an opening 14 for inserting an ingredient capsule into flavouring module 10. In the configuration illustrated in FIG. 1, opening 14 is covered by the machine's housing. In the configuration illustrated in FIG. 2, opening 14 is moved passed axis 1′ in front of a corresponding opening of the machine's housing (not shown). In FIG. 1, the housing's opening is covered by plate-like element 102 of indicator 1. In FIG. 2, indicator 1 is pivoted upright so that element 102 uncovers opening 14 and the housing's opening. In this configuration, downstream part 11 is spaced from the upstream part so as to permit insertion of an ingredient capsule into flavouring module 10 via opening 14 and the housing's opening.

Indicator 1 has a toothed wheel portion 101 that engages with a toothed rack potion 15 of downstream portion 11 when portion 11 is translated underneath the machine's housing from the configuration shown in FIG. 1 to the configuration shown in FIG. 2. Hence, indicator 1 that is pivotally mounted in the machine's housing along axis 1′ is pivoted upwards by the motion of portion 11.

Indicator 1 with its plate-like element 102 in the configuration of FIG. 1 indicates that opening 14 is not accessible and that flavouring module 10 is in its closed configuration. Indicator 1 with its plate-like element 102 in the configuration of FIG. 2 indicates that opening 14 is accessible for inserting an ingredient capsule and that flavouring module 10 is in its open configuration.

Such a indication to a user is of particular interest when the opening and closing of flavouring module 10 is done automatically, e.g. by an electric motor. In such a case, the user may not rely on the position of an actuating handle to determine the status of flavouring module 10.

In the particular embodiment illustrated in FIGS. 1 and 2, indicator 1 is arranged to illustrate two different status, i.e. corresponding to an open and a closed configuration of flavouring module 10. It is of course possible to configure the processing unit to indicate a further status, e.g. a start-up status, by bringing indicator 1 in an intermediate position between the positions illustrated in FIGS. 1 and 2, typically during start-up of the heater upon switch-on of the beverage preparation machine.

To further increase the ergonomics of the indicator, a marking may be provided on indicator 102. For instance, indicator 102 shown in FIG. 1 may bear on its user-visible face (top face), a sign indicating that the flavouring module is in its closed position, such as “brewing chamber closed” or a no-way pictogram; indicator 102 shown in FIG. 2 may bear on the opposite face, e.g. adjacent passage 14, a sign indicating that flavouring module 10 is in its open position, such as “brewing chamber open” or an arrow indicating the direction for supplying an ingredient into the chamber.

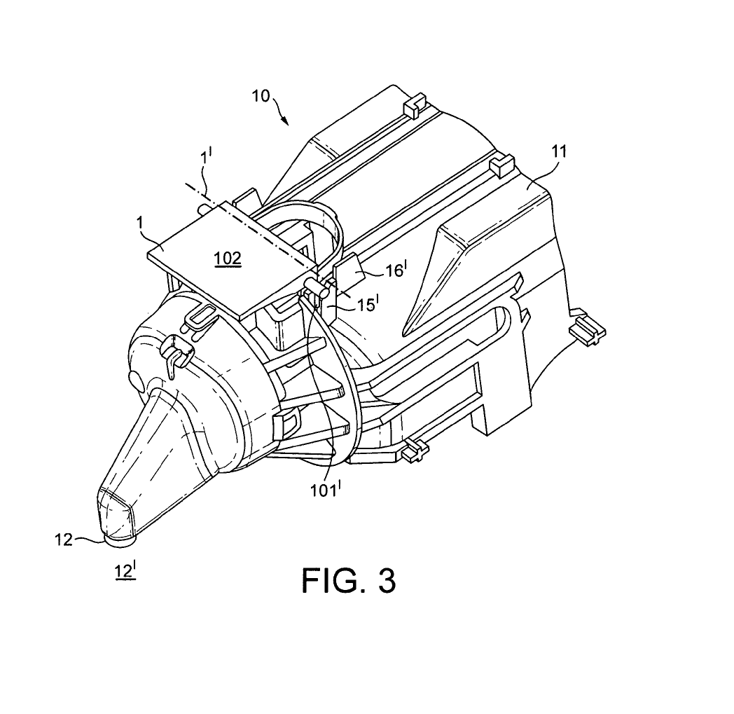

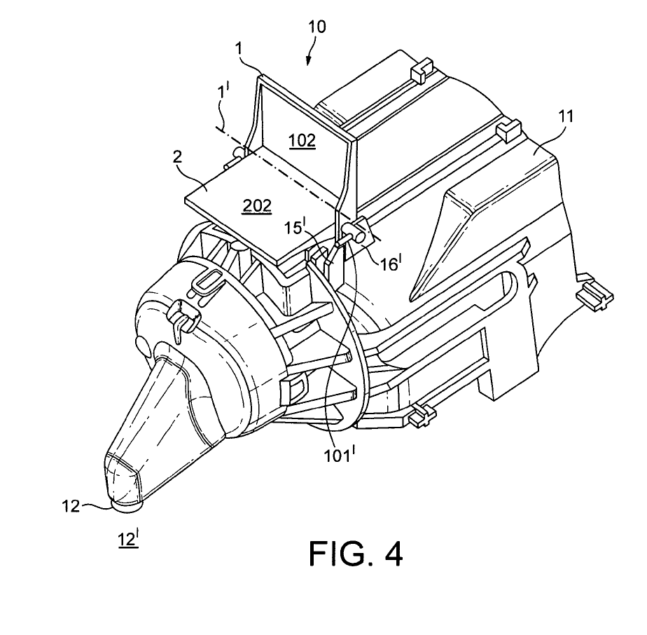

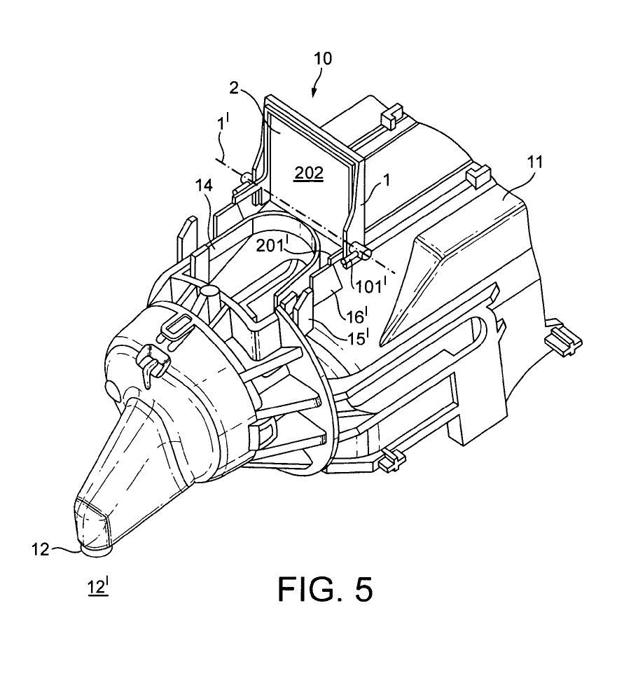

FIGS. 3 to 5, in which the same numeric references generally designate the same elements, illustrate a variation of the particular embodiment shown in FIGS. 1 and 2. User-interface 1,2 includes a first indicator 1 and a second indicator 2 with first and second plate-like elements 102,202, respectively, pivotally mounted about axis 1′ in the machine's housing (not shown). Indicators 1,2 include drive arms 101′,201′ that are pushed by members 15′,16′, respectively, of downstream part 11 when moved away from the upstream part (not shown). In the configuration shown in FIGS. 3 to 5, indicators 1,2 are sequentially moved by the corresponding members 15′,16 so that at the passage of downstream part 11, indicator 1 is first pivoted from the position shown in FIG. 3 to the upright position in FIG. 4 and indicator 2 is pivoted upwards by further moving downstream part 11 away from the upstream part into the position shown in FIG. 5.

Hence, Indicator 1 with the plate-like element 102 in the low configuration is used to indicate the closed position in FIG. 3, e.g. for preparing and dispensing a beverage. Indicator 2 with the plate-like element 202 is used to indicate the open position in FIG. 5, e.g. for inserting and/or evacuating an ingredient capsule into flavouring module 10. Indicator 1 pivoted up and indicator 2 pivoted down are used to indicate an intermediate configuration, e.g. during the start-up of the beverage machine, as illustrated in FIG. 4. For improving the ergonomics of indicators 1,2, plate-like elements 102,202 may bear markings, such as “open”, “closed”, “start-up”, etc. . . .

FIGS. 6 to 8b, in which the same numeric references designate generally the same elements, illustrate a further embodiment of an interface 3,4 of a beverage machine according to the invention. FIGS. 6, 7 and 8 show cross-sectional views of upstream part 11 of flavouring module 10 in a machine's housing 20. FIGS. 6a, 7a and 8a show corresponding top views of interface 3,4 on housing 20. FIGS. 6b, 7b and 8b show corresponding views of the actuation of interface 3,4 by the movement of downstream part 11.

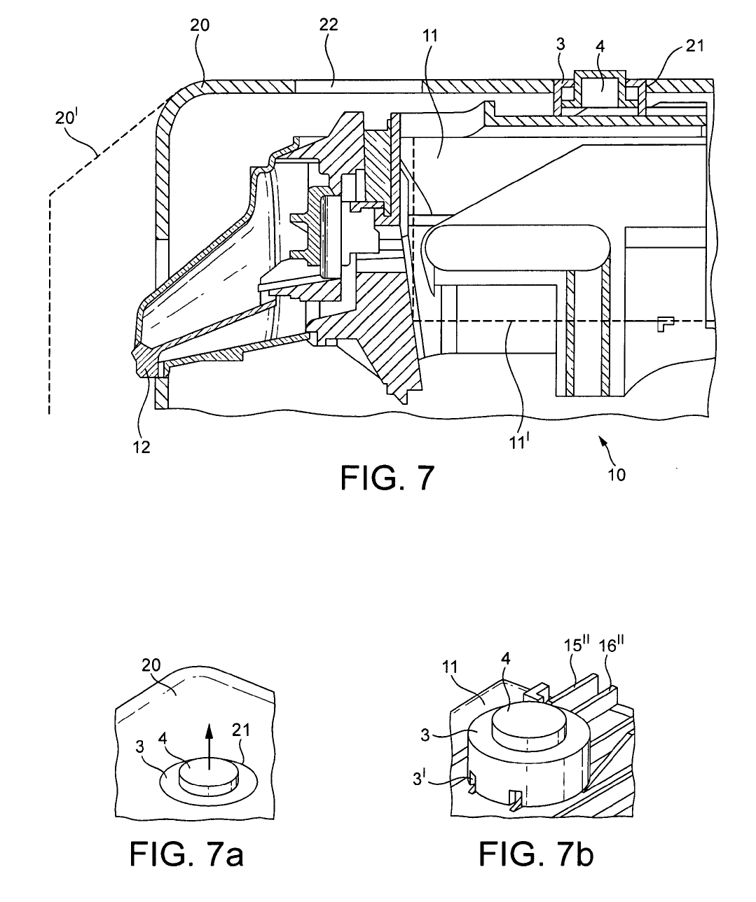

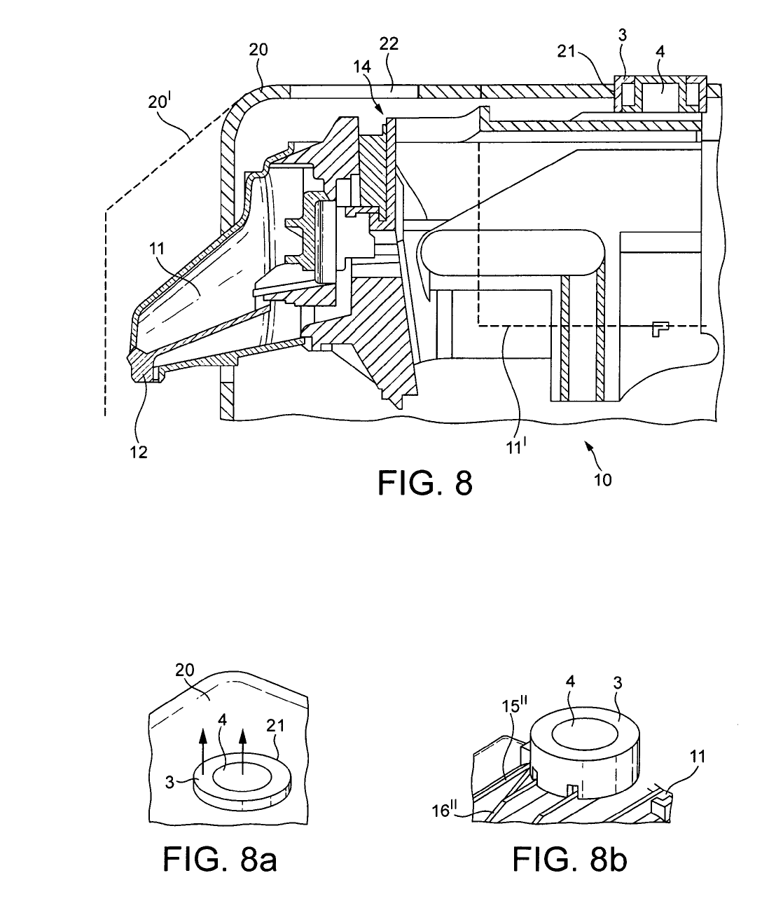

Front part 11 is urged in the closed position against a rear part 11′ as indicated in FIG. 6. Front part 11 is movable away from rear part 11′ via an intermediate position shown in FIG. 7 into an open position shown in FIG. 8. Front part 11 may telescope in an out of housing 20. A front cover 20′, such as a secondary housing element or part, may be used to shield front part 11 when telescoped out of main housing 20.

In the open position (FIG. 8), front part 11 is spaced apart from part 11′ so that a channel 14 is formed therebetween for inserting an ingredient capsule from outside housing 20 via housing opening 22 located above channel 14 into flavouring module 10.

Interface's indicators 3,4 are in the form of generally tubular/cylindrical concentric members that are actuated by pushers 15″,16″, respectively, incorporated in movable downstream part 11. At the passage of downstream part 11, indicators 3,4 telescope through an opening 21 in housing 20 and retract thereinto. In a variation, such indicators 3,4 may move entirely or substantially outside or inside the housing or may move in the absence of an adjacent housing.

Indicators 3,4 are actuated by the displacement of movable part 11 of flavouring module 10. Part 11 has a geometry 15″,16″ appropriate to displace indicators by moving between the open and closed position of module 10, e.g. in a cam-follower 3,4 cam 15″,16″ type of arrangement. In particular, movable part 11 bears a first ramp arrangement 15″ and a second ramp arrangement 16″. Ramps 15″,16″, as illustrated in this particular example, are in a side-by-side staggered arranged so that on moving ramp 16″ from the closed to the open position, i.e. in the sequence illustrated from FIGS. 6,6a,6b (closed position) via FIGS. 7, 7a, 7b (intermediate position) to FIGS. 8,8a,8b (open position), indicators 3,4 are sequentially raised. Likewise, indicators 3,4 are sequentially lowered when movable part 11 is displaced from the open to the closed position. The lowering of indicators 3,4 may be carried out by gravity or a spring element or any other suitable means.

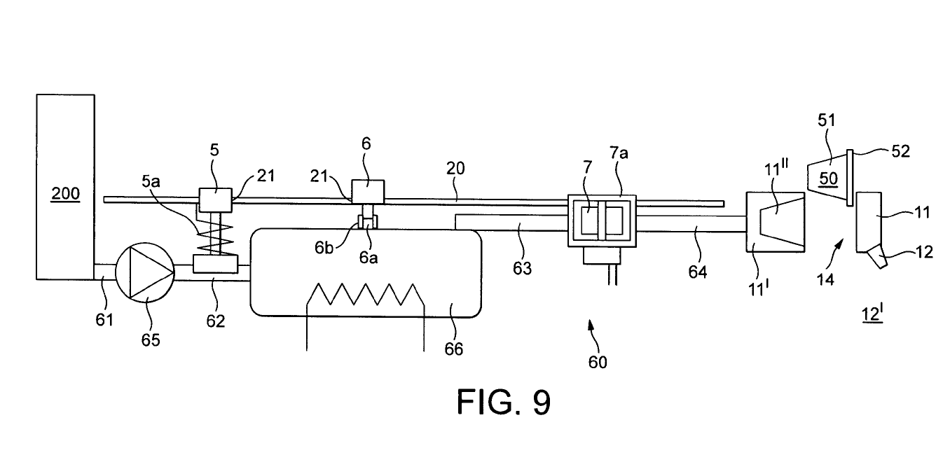

Ramps 16″ are located inbetween ramps 15″. Peripheral indicator 3 has bottom openings 3′ for permitting the unhindered passage of ramps 16″ that move inner or central indicator 4 (FIGS. 7,7a,7b). Outer or peripheral indicator 3 is moved by outer ramps 15″ (FIGS. 8,8a,8b).

Whereas FIGS. 1 to 8b illustrate mechanical interfaces with indicators 1 to 4 for indicating a status related to flavouring module 10, indicators 5,6,7 schematically shown in FIG. 9 provide information to a user on other parts of a beverage machine according to the invention. These indicators may all be combined. Alternatively, only one or more of such indicators may be implemented in a given machine.

FIG. 9, in which the same numeric references generally designate the same elements, illustrates a processing unit 60 of a particular embodiment of a beverage preparation machine in accordance with the invention. Processing unit 60 is connected to a source of liquid 200. Source of liquid 200 may be part of the beverage machine, e.g. a liquid reservoir 200 connected to processing unit 60, of may be tap. Further details on this type of reservoirs are for example disclosed in EP 10163637.1. Hence, source of liquid 200, without being part of processing unit 60, supplies unit 60 with the required liquid.

Processing unit 60 has a fluid circulation arrangement including a series of pipes 61,62,63,64 interconnected via pump 65 and resistive in-line heater 66 to a flavouring module 10, e.g. a brewing unit, with a beverage outlet 12. Flavouring unit 10 has a movable part 11 that cooperates with part 11′ to receive a flavouring ingredient capsule 50 into cavity 11″ and circulate a carrier liquid, e.g. water, therethrough to form a beverage.

The beverage processing unit 60 in housing 20 has a flavouring module 10 arranged for holding a flavouring ingredient, in particular a pre-portioned ingredient such as an ingredient supplied to such module within a capsule, and circulating a liquid therethrough to form a beverage. Flavouring capsule 50 has a cup-shaped body 51 with a rim for fixing a lid 52 thereon. Body 51 is configured for containing a pre-portioned amount of flavouring ingredient. Examples of modules for such capsules 50 are disclosed in WO 2009/074550 and in WO 2009/130099, the teachings of which are hereby incorporated by way of reference.

The machine may have a collector receptacle (not shown) for collecting used ingredients, such as tea leaves or ground coffee, e.g. within used capsules, and waste liquid. The collector receptacle, e.g. waste collector, may be located in a lower part of housing 20 of the machine and have an upper compartment for solids and a lower compartment for liquids. Collector receptacle may be insertable, e.g. slidable, into a cavity formed in the machine and removable therefrom for servicing, e.g. emptying the solids and/or liquids contained therein. For example, the storage capacity of the collector receptacle for accumulating used ingredient may be aligned to the storage capacity of reservoir for the supply of liquid such as water, e.g. as taught in PCT/EP10/056,194.

The collector receptacle is positioned underneath the beverage preparation flavouring module 10 to collect upon beverage preparation the used flavouring ingredient, e.g. ground coffee or tea, evacuated to the receptacle via an ingredient introduction/evacuation passage 14, e.g. by gravity. The receptacle typically has an anti-clogging arrangement, as for example taught in WO 2009/074559 and in WO 2009/135869, which are hereby incorporated by way of reference.

Hence, processing unit 60 is arranged to intake liquid from source 200, drive liquid via pump 65 into heater 66 and flavouring module 10 containing capsule 50 to form a beverage. The beverage, upon formation, is dispensed via outlet 12 to a dispensing zone thereunder, e.g. delimited at the bottom by a support surface for holding a user cup or mug. Such support surfaces are well known in the art, e.g. as disclosed in EP 1 867 260 and WO 2009/074557.

Processing unit 60 cooperates with user indicators 5,6,7 for indicating to a user the status of different parts of unit 60. Indicators 5 and 6 are arranged to telescope through housing 20 in and out of the beverage machine to indicate a particular status of the beverage preparation machine. Indicator 7 is arranged to move behind a transparent casing 7a.

Indicator 5 is configured to indicate a pressure in pipe 62 downstream pump 65. Indicator 5 is mechanically connected to flexible pipe 62 and urged thereagainst by spring 5a. When pump progressively pressurizes liquid from source 200 and drives the liquid under pressure, e.g. at 10 to 20 bar, via flexible pipe 62, flexible pipe progressively expands in cross-section, stresses spring 5a and pushes indicator outwards housing 20. When the pressure is released in pipe 62, spring 5a pushes indicator against pipe 62 which is then compressed in cross-section. Hence, movements of indicator 5 indicate the pressure status in processing unit 60.

Indicator 6 is connected via a thermally expanding material 6a to thermal conditioner 66. Expanding material 6a is confined within a cylinder 6b between indicator 6 and conditioner 66. When the temperature of conditioner 66 increases, material 6a progressively expands and pushes indicator 6 outwards housing 20 progressively. When the temperature of conditioner 66 decreases, material 6a progressively contracts and retracts indicator 6 inwards housing 20 progressively. Hence the position of indicator 6 indicates to the user the thermal status of conditioner 66. In particular, a state of non-readiness of thermal conditioner 66, and thus of processing unit 60, may be indicated to a user via non-electric interface indicator 6.

Indicator 7 is in the form of a rotatable flow measuring body in a housing 7a, e.g. a transparent flowmeter. The rotation of indicator 7 behind transparent wall of housing 7a is visible to a user from outside the beverage machine. Hence, indicator 7 will indicate to a user circulating of liquid via pipes 63,64 whether liquid is circulated to flavouring chamber 11″ or not. For instance, the machine's fluid circuit may be arranged to carry out a rinsing or cleaning process in which fluid is evacuated from processing unit 60 from inbetween parts 11,11′ into a service unit, instead as from outlet 12 into a user-mug or user-cup. Moreover, the rotational speed of indicator 7 will indicate the velocity of the liquid in pipes 63,64.

1. A beverage machine comprising:
a processing unit having a flavoring module for mixing liquid with a flavoring ingredient to form a flavored beverage, and having a liquid drive arrangement for receiving liquid from a source of liquid and driving the liquid to the flavoring module, and an outlet for guiding a flavored beverage from the flavoring module to a beverage dispensing area;
a user-interface that is connected to the processing unit and has an indicator for indicating a status of the processing unit; and
the indicator is displaceable, in a manner visible from outside the machine by a mechanical, magnetic and/or thermal actuation thereof by the processing unit changing status.

2. The machine of claim 1, wherein the indicator is movable incrementally, with a change of status of the processing unit.

3. The machine of claim 1, wherein the indicator is movable progressively with a corresponding change of status of the processing unit.

4. The machine of claim 1, having an outermost housing, the indicator extending through the outermost housing.

5. The machine of claim 1, comprising an outermost housing, the indicator being arranged to move inside the housing behind a transparent part of the housing and/or behind an opening of the housing.

6. The machine of claim 1, wherein the indicator is translationally movable between two predetermined end positions.

7. The machine of claim 1, wherein the indicator is pivotally movable between two predetermined end positions.

8. The machine of claim 1, wherein the indicator is infinitely movable.

9. The machine of claim 1, wherein the processing unit comprises a thermal conditioner of the in-taken liquid, the indicator being arranged for indicating a thermal status of the thermal conditioner.

10. The machine of claim 9, wherein the indicator comprises a temperature-sensitive mechanical element in thermal communication with the thermal conditioner.

11. The machine of claim 1, wherein the processing unit comprises a part that is movable by a change of status and that is mechanically connected to the indicator so as to displace the indicator when the part is moved.

12. The machine of claim 11, wherein the movable part of the processing unit forms a part of the flavoring module.

13. The machine of claim 12, wherein the flavoring module comprises a further part that cooperates with the movable part, the movable part being movable away from the further part for introducing a flavoring ingredient, into the flavoring module and/or for evacuating a used flavoring ingredient therefrom and towards the further part for forming a mixing cavity that holds such flavoring ingredient and that guides a flow of liquid therethrough for flavoring such liquid and that is arranged to deliver such flavoured liquid to a beverage outlet.

14. The machine of claim 13, wherein the movable part of the flavoring module is motorized.

15. The machine of claim 11, wherein the processing unit comprises a fluid conduit that is associated with at least one characteristic selected from the group consisting of:
a body drivable by a change of pressure in the fluid conduit;
a body drivable by a flow in the fluid conduit; and
a pump having a drive body.
